(19) United States
(12) Patent Application Publication
(10) Pub. No.: US 2026/0099523 A1
(43) Pub. Date: Apr. 9, 2026

(54) SYSTEMS AND METHODS FOR BLOCK PROCESSING TIME SERIES INTEGRATION

(71) Applicant: MongoDB, Inc., New York, NY (US)

(72) Inventors: Ian Boros, New York, NY (US); Geert Bosch, Brooklyn, NY (US); Alberto Massari, New York, NY (US); Martin Neupauer, Freehold, NY (US); Andrew Paroski, New York, NY (US); Michael Gargiulo, New York, NY (US)

(73) Assignee: MongoDB, Inc., New York, NY (US)

(21) Appl. No.: 19/347,529

(22) Filed: Oct. 1, 2025

Related U.S. Application Data
(60) Provisional application No. 63/702,532, filed on Oct. 2, 2024.

(51) Int. Cl. G06F 16/334

(52) U.S. Cl. CPC G06F 16/334

(57) ABSTRACT

A system comprising a pipeline is provided comprising a first stage configured to create a plurality of BSON documents from input data, a block processing stage configured to format the plurality of BSON documents into one or more blocks and to provide an access interface to the one or more blocks, a query stage configured to execute a query to the one or more blocks using the access interface to generate an output array responsive to the query; and a decomposition stage configured to transform the output array into one or more slots of scalar data values.

### CROSS-REFERENCE TO RELATED APPLICATIONS

This application claims the benefit under 35 U.S.C. § 119 (c) of U.S. Provisional Application No. 63/702,532 entitled “SYSTEMS AND METHODS FOR BLOCK PROCESSING TIME SERIES INTEGRATION,” filed Oct. 2, 2024, the entire contents of which are incorporated herein by reference by its entirety.

This Application relates to U.S. patent application Ser. No. 17/858,950, filed Jul. 6, 2022, entitled “SYSTEMS AND METHODS FOR PROCESSING TIMESERIES DATA” and to U.S. patent application Ser. No. 18/358,212, entitled “SYSTEMS AND METHODS FOR PROCESSING TIMESERIES DATA.” The entire contents of these applications are attached as appendices to this application and form an integral part of the present application

### NOTICE OF MATERIAL SUBJECT TO COPYRIGHT PROTECTION

Portions of the material in this patent document are subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### SUMMARY

Query systems and their interfaces to storage are sometimes based on a one-at-a-time processing model. The query plan requests a value (e.g., a BSON (Binary JavaScript Object Notation, a KeyString), the storage finds it, returns it, and then it is processed. This works well for typical “find a few documents with an index” queries. However, for queries that process a large amount of data, the one-at-a-time model is not ideal. Time series queries may fall into the category of operations that read a lot of data. With time series, the data is kept in a compressed form and engines may spend a lot of time reshaping the data into single documents, just to spend more time executing the plan on each of them, as if they had come from a regular collection.

Time series collections have another feature that can be exploited to boost performance: they collect some metadata (like minimum and maximum value of each block of values) that in some carefully selected scenarios could allow computation of the result of an operation even without decompressing the data from its storage format, effectively evaluating hundreds or thousands of values with just a few basic operations.

Therefore, according to some aspects described herein, it is appreciated that it would be useful to be able to extend a query engine (e.g., a SBE (Slot-Based query execution Engine)) so that a single invocation of a getNext( ) method in a PlanStage-derived class can perform work on a block of values rather than a single value. In some embodiments as described herein, such a query engine may be used in association with a non-SQL database such as a document-based database (e.g., BSON documents) such that block processing functions may be applied to the document-type databases wherein the data to be operated on may be located in various locations within the document database.

According to some additional aspects described herein, it is appreciated that it would be useful to be able to exploit block-level summary information when evaluating expressions in new block-aware primitives.

According to some additional aspects described herein, it is appreciated that it would be useful to allow expressions to be computed on top of the block storage format, when possible, to avoid costly memory allocations and the movement of data.

According to some additional aspects described herein, it is appreciated that it would be useful to allow the creation of a hot cache of both data and instructions for the cases when the operation performs its task on individual values sequentially. It is further appreciated that it is possible to use Single Instruction, Multiple Data (SIMD) instructions in some of these cases.

According to one aspect, a system is provided. The system comprises a pipeline comprising: a first stage configured to create a plurality of BSON documents from input data; a block processing stage configured to format the plurality of BSON documents into one or more blocks and to provide an access interface to the one or more blocks; a query stage configured to execute a query to the one or more blocks using the access interface to generate an output array responsive to the query; and a decomposition stage configured to transform the output array into one or more slots of scalar data values.

In some embodiments, the input data comprises time series data. In some embodiments, the one or more blocks comprises a plurality of type and value pairs. In some embodiments, the query stage is further configured to traverse a vectorized path through the one or more blocks. In some embodiments, the one or more blocks comprises metadata and the query is executed in accordance with the metadata. In some embodiments, the query is executed in accordance with one or more block properties. In some embodiments, the one or more blocks comprises cells, wherein a single cell corresponds to a single path within the BSON document. In some embodiments, the query stage is further configured to unwind blocks.

According to another aspect, a method is provided, the method creating a plurality of BSON documents from input data; formatting the plurality of BSON documents into one or more blocks and providing an access interface to the one or more blocks; executing a query to the one or more blocks using the access interface to generate an output array responsive to the query; and transforming the output array into one or more slots of scalar data values.

In some embodiments, the input data comprises time series data. In some embodiments, the one or more blocks comprises a plurality of type and value pairs. In some embodiments, the method further comprises traversing a vectorized path through the one or more blocks. In some embodiments, the one or more blocks comprises metadata and the query is executed in accordance with the metadata. In some embodiments, the method further comprises executing the query to the one or more blocks in accordance with one or more block properties. In some embodiments, the one or more blocks are formatted such that a single cell corresponds to a single path within the BSON documents. In some embodiments executing the query to the one or more blocks includes unwinding the blocks.

According to another aspect, a method for processing data blocks in a database system is provided, the method receiving a block of data values, where the block comprises a plurality of type and value pairs; providing an interface configured to access the block of data values, where the interface comprises: an extraction method configured to return contents of the block as types and values in array form; a mapping method configured to apply operations to the block; and one or more metadata methods configured to return at least one of minimum value, maximum value, count, first value, or last value when available; detecting that the block contains values of a same data type; invoking a batch operation on a contiguous buffer of the same data type values using vectorized instructions to process multiple values simultaneously; and generating an output block containing results of the batch operation.

In some embodiments, the interface comprises a ValueBlock interface. In some embodiments, the vectorized instructions comprise Single Instruction Multiple Data (SIMD) instructions. In some embodiments, the batch operation processes values in batches of 8, 16, or 32 values at one time. In some embodiments, the mapping method is configured to apply a column operation that includes at least one of basic operation callback, a batch operation, or property flags indicating operation characteristics. In some embodiments, the property flags include at least one of deterministic, monotonic, owns result, ignore value, or has side effects. In some embodiments, the metadata methods return values in constant time without processing individual data values in the block. In some embodiments, the block comprises at least one of homogenous block containing values of the same type, a heterogeneous block containing values of different types, or a compressed block in run-length encoding format. In some embodiments, the batch operation comprises at least one of comparison operations, arithmetic operations, date operations, or type checking operations applied to the contiguous buffer. In some embodiments, the method further comprises, applying a validity map to the block to indicate which values should be processed and which should be ignored during the batch operation. In some embodiments, the interface further comprises a tokenization method configured to convert the block into dictionary compressed form with index-to-token mappings. In some embodiments, the data values are stored in at least one of BSON format, time series format, or columnar storage format, and the batch operation is performed without converting the data values to a different format. In some embodiments, the vectorized instructions utilize CPU vector registers including at least one of SSE2 128-bit registers, AVX2 256-bit registers, or AVX-512 512-bit registers to process multiple data elements in parallel.

In another aspect, a non-transitory computer-readable medium is provided containing instructions that, when executed, cause at least one computer hardware processor to perform: creating a plurality of BSON documents from input data; formatting the plurality of BSON documents into one or more blocks and providing an access interface to the one or more blocks; executing a query to the one or more blocks using the access interface to generate an output array responsive to the query; and transforming the output array into one or more slots of scalar data values. In some embodiments, the input data comprises time series data. In some embodiments, the one or more blocks comprises a plurality of type and value pairs. In some embodiments, the instruction of the non-transitory computer-readable medium causes the computer hardware processor to further perform traversing a vectorized path through the one or more blocks. In some embodiments, the one or more blocks comprises metadata and the query is executed in accordance with the metadata.

One or more aspects as described herein may be practiced alone or in combination with any embodiments described in U.S. patent application Ser. No. 17/858,950, filed Jul. 6, 2022, entitled “SYSTEMS AND METHODS FOR PROCESSING TIMESERIES DATA.” Further, one or more aspects as described herein may also be practiced alone or in combination with any embodiments described in U.S. patent application Ser. No. 18/358,212, entitled “SYSTEMS AND METHODS FOR PROCESSING TIMESERIES DATA.”

Still other aspects, examples, and advantages of these exemplary aspects and examples, are discussed in detail below. Moreover, it is to be understood that both the foregoing information and the following detailed description are merely illustrative examples of various aspects and examples and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF DRAWINGS

Various aspects of at least one embodiment are discussed herein with reference to the accompanying figures, which are not intended to be drawn to scale. The figures are included to provide illustration and a further understanding of the various aspects and embodiments and are incorporated in and constitute a part of this specification but are not intended as a definition of the limits of the invention. Where technical features in the figures, detailed description or any claim are followed by references signs, the reference signs have been included for the sole purpose of increasing the intelligibility of the figures, detailed description, and/or claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. In the figures:

FIG. 1 shows a block diagram of an example distributed database system that may be used to store timeseries data, according to some embodiments;

FIG. 2 shows an example schema that may be used to store timeseries data;

FIG. 3 shows an example distributed system that may be used to store and archive timeseries data;

FIG. 4 shows a block diagram of an exemplary execution model, according to some embodiments;

FIG. 5 shows a high-level view of an exemplary scalar pipeline, according to some embodiments;

FIG. 6 shows a high-level view of another exemplary pipeline, according to some embodiments;

FIG. 7 shows a block diagram of an exemplary Block Processing Stage, according to some embodiments.

FIG. 8 shows a block diagram of a process for Block Representation, according to some embodiments;

FIG. 9 shows a block diagram of an another exemplary execution model, according to some embodiments;

FIG. 10 shows a block diagram of an exemplary Query Stage Process, according to some embodiments;

FIG. 11 shows a high-level view of another exemplary pipeline, according to some embodiments.

FIG. 12 shows a high-level view of another exemplary pipeline, according to some embodiments.

FIG. 13 shows a high-level view of another exemplary pipeline, according to some embodiments.

FIG. 14 shows a block diagram of an example special-purpose computer system, according to some embodiments; and

FIG. 15 shows a block diagram of an example disk or flash memory according to some embodiments.

### DETAILED DESCRIPTION

As discussed, various aspects relate to database architecture, interfaces, operators and processes related to performing block processing in a nonstructured database, such as a noSQL database type (e.g., a MongoDB database) which stores data as unstructured documents. It is appreciated that in some document databases, data may be located in disparate locations, and it is inefficient to perform operations on individual data entries. In some cases, such as in a time series database having data stored in compressed format in a columnar data store, there are inefficiencies in unpacking and reshaping a large volume of compressed data. In some embodiments, block processing capabilities are provided that permit operations to be performed on multiple elements stored among a group of documents. In some implementations, systems and methods are provided that permit operations to be performed on blocks of data at once, leveraging column-level summaries or other metadata while avoiding the overhead of packing and reshaping documents. This capability significantly improves performance, particularly for aggregation operations (e.g., $match, $sort, $group, etc.). Also, this capability permits operations to be performed on data without decompression of the storage format.

In some embodiments, a result will be returned one BSON value at a time. Some embodiments enable the creation of a section of a pipeline where the data will be processed in blocks rather than one value at a time. This operation will be referred to as either “block” or “vectorized” processing. Some embodiments may include a special block-to-scalar conversion stage that may emit a single component of the input block at each advance (i.e., getNext( ) of the output iterator, until the block has no more values inside. On the next advance, a new block will be pulled from the producer to the conversion stage (and recursively all the underlying block stages) of the pipeline and the extraction will restart.

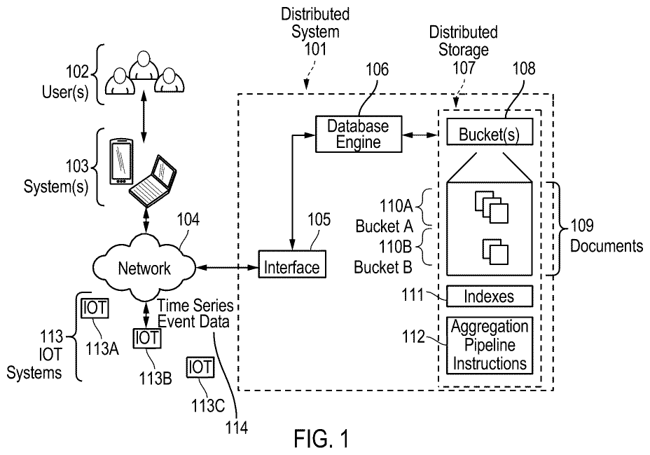

FIG. 1 shows a block diagram of an example distributed database system 101 that may be used to store time series data, according to some embodiments. In particular, a distributed system 101 is provided that includes a number of components coupled to one or more networks (e.g., network 104). Distributed system 101 fulfills one or more database operations requested by one or more systems 103 which may be, in some embodiments, in turn operated by one or more users 102 or other entities. For instance, in some examples, applications running on end user devices may be programmed to use a database for underlying data management functions. It should be appreciated that other systems, applications, client systems, or other entities may use database services.

In some embodiments as described herein, one or more data sources may generate time series event data 114 which is then processed and stored by database engine (e.g., database engine 106). For example, time series data may be generated by one or more systems such as those that may typically create event data such as in the manufacturing, financial services, or other types of systems. In some embodiments, one or more IoT systems (e.g., systems 113 (elements 113A-113C)) may generate events which are stored within the distributed system 101. For example, it is appreciated that there may be a number of systems that can generate and store time series data that may be stored by distributed system 101, and various embodiments are not limited to any particular number or type of data generating systems.

Time series event data is passed to distributed system 101, received by an interface (e.g., interface 105) and forwarded to a database engine 106 which is configured to perform one or more database operations. Database engine 106 may include a number of elements including processors, elements such as routers, or other elements. Database engine 106 may include any entity related to storing data, may include hardware and/or software. In some embodiments, the database engine may include one or more processes and one or more storage entities that manage and store database entities such as documents. In some embodiments, the database engine may include a modified mongo process (commercially available from MongoDB) that is executed by a processor. Data is stored in a distributed storage entity 107 which includes one or more systems and/or storage elements.

In some embodiments, a logical structure is defined referred to herein as a bucket (e.g. bucket 108) which defines a period of time in which event data may be stored. Storage 107 may store one or more buckets (e.g., bucket A (element 110A), bucket B (element 110B)). These buckets may contain one or more documents 109 that correspond to event data collected from one or more systems. Further, system 101 may include one or more indexes used to index time series data, one or more pipeline operators used to perform operations on time series data, and other elements used to facilitate time series operations (e.g., windowing commands). In some embodiments, the Distributed Storage 107 stores user(s) 102 provide Aggregation Pipeline Instructions 112 (e.g., $match, $sort, $group, etc.) to perform query on a group of User(s) Data.

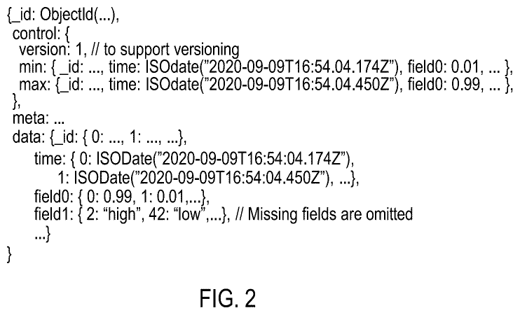

FIG. 2 shows as an example schema format that may be used to store time series data in a bucketized format. For example, the_id is chosen by the database server and is an ObjectId. The control field is an object that includes the version number as well as min and max fields that hold the minimum and maximum value of each field as determined by a BSON comparison order, taking into account any specified collation. The minimum/maximum of two BSON documents or of two arrays is the field-by-field minimum or maximum. The meta field may be of any BSON type and contains either the value of the metaField field as specified at collection creation time, or null if that field is absent. This means that measurements with explicit null metadata and absent metadata will be placed into the same bucket. Measurements with an equal meta field (ignoring field order, and not considering collation) are included in the same bucket. The data field is an object that contains a nested object for each field (e.g., ‘id’, ‘time’, ‘field0’, etc.) present in any of the inserted measurements. These nested objects have field names that are decimal string representations of an incrementing counter starting at “0”, reflecting the number of measurements inserted so far.

As discussed, by storing time series data as a collection of buckets and associated documents, other operations and functions may be performed on this time series data. For example, methods may be provided for sampling data elements over buckets, performing bucket unpacking operations, performing densification operations on data sets, archiving data buckets to cold storage, performing fast deletes of bucket data, performing windowing operations, among other functionalities that can be used with time series data. Similarly, metadata (like minimum and maximum value of each block of values) that in some carefully selected scenarios could allow computation of the result of an operation even without decompressing the data from its storage format, effectively evaluating hundreds or thousands of values with just a few basic operations.

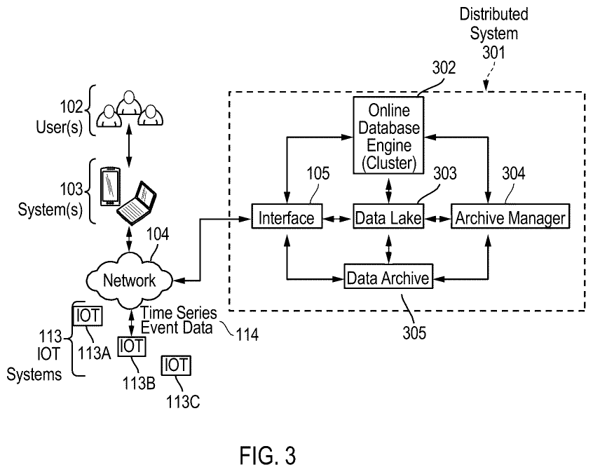

FIG. 3 shows an example distributed system that may be used to store and archive timeseries data in accordance with various embodiments. In some embodiments, it is appreciated that timeseries data may be stored in one or more systems and databases, and in some embodiments, timeseries data may be more intelligently archived to long term (or cold) storage.

FIG. 3 shows a block diagram of an example distributed database system 301 according to some embodiments. In particular, a distributed system 301 is provided that includes a number of components coupled to one or more networks (e.g., network 104). Distributed system 301 fulfills one or more database operations requested by one or more systems 103 which may be, in some embodiments, in turn operated by one or more users 102 or other entities. For instance, in some examples, applications running on end user devices may be programmed to use a database (e.g., a DaaS) for underlying data management functions. It should be appreciated that other systems, applications, client systems, or other entities may use database services. As discussed, the system may be configured to store and process timeseries data generated by one or more systems (e.g., timeseries event data generated by loT systems 113).

In some embodiments, distributed system 301 includes a hot-storage-type database as well as a cold-storage-type database for fulfilling database requests. In one embodiment, the distributed system provides a single access interface 105 performing database operations on both types of databases. In some examples, the online database is a DaaS-type database and may include, for example, cluster-based system. Online database engine 302 may be provided that performs read and write operations to storage entities configured in a database cluster (e.g., a cluster-based database such as the ATLAS database commercially available from MongoDB).

In some embodiments, an archive manager (e.g., archive manager 304) is provided that controls how data is archived from the online database to a data archive (e.g., data archive 305). In some implementations, the data archive may be implemented as cloud-based storage elements. For example, the data archive may use data buckets to create one or more archives associated with an online database. In some embodiments, a capability is provided for archiving data by the database management system that reduces management effort on behalf of application creators. In some embodiments, an archive manager 304 is provided that automatically archives data from an online database to an off-line database while maintaining a single point of interface to the database. In this manner, archiving operations are transparent to end user applications.

Further, a database may be provided that fulfills data read operations from one or more hot and cold data sources. In some embodiments, a data lake (e.g., data lake 303) is provided that provides a single view of offline and online storage. As is known, data lakes generally have the ability to store both structured and unstructured data. In some embodiments, the data lake may service read operations that reference an online database. In some embodiments, the database is a DaaS-based database that implements online storage using a cluster of nodes (e.g., online database (cluster) 302). Further, the data lake services read operations to a data archive (e.g., data archive 305, such as for example, one or more S3 data buckets). In some embodiments, the data lake may be used as a single view of online cluster data and archive data.

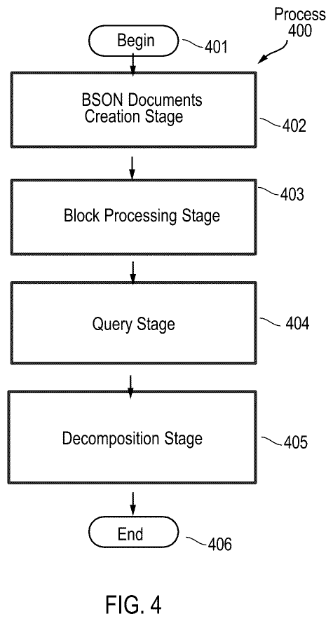

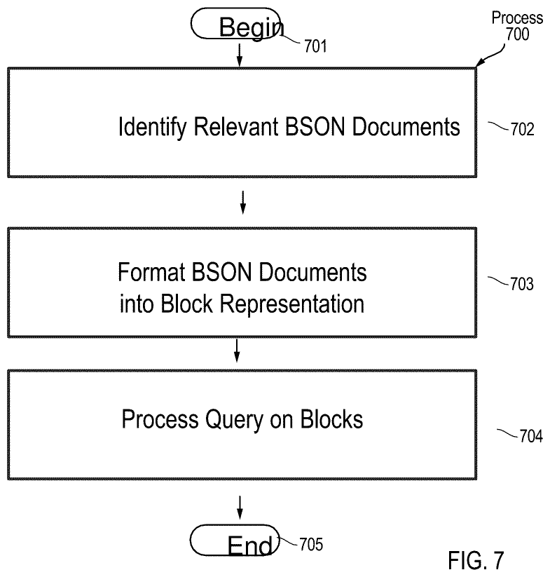

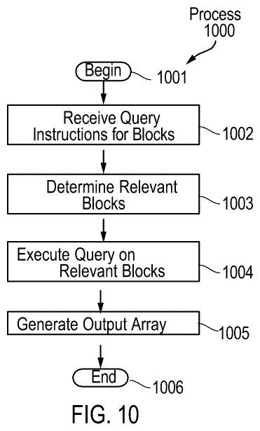

FIG. 4 shows a block diagram of an exemplary execution model, according to some embodiments. More particularly, FIG. 4 shows a high-level view of an exemplary pipeline according to some embodiments that processes input value by leveraging block processing. In some embodiments, the first stage is a BSON Documents Creation Stage 402. In some embodiments, BSON Documents Creation Stage 402 may be configured to create a plurality of BSON documents from input data. This may include, but not limited to, creating BSON documents and storing them in a Distributed System 101. In some embodiments, the pipeline as shown in FIG. 4 may include a Block Processing Stage 403. Block Processing Stage 403, in some embodiments, may be configured to format the plurality of BSON documents into one or more blocks and to provide an access interface to the one or more blocks. In some embodiments, this stage may start with mapping the stored data format into blocks and provide an access interface to the blocks. The access interface to the blocks may allow for block processing the blocks per user query requests. More particularly, these requests may be stored in Aggregation Pipeline Instructions 112. FIG. 7 shows a high-level view of an exemplary Block Processing Stage, according to some embodiments. In some embodiments, Query Stage 404 is configured to execute a query to the one or more blocks using the access interface to generate an output array responsive to the query. FIG. 10 shows a block diagram of an exemplary Query Stage Process, according to some embodiments. In some embodiments, Decomposition Stage 405 is configured to transform the output array into one or more slots of scalar data values. In some embodiments, the scalar data values may reflect the desired output or result to a requested query by a user.

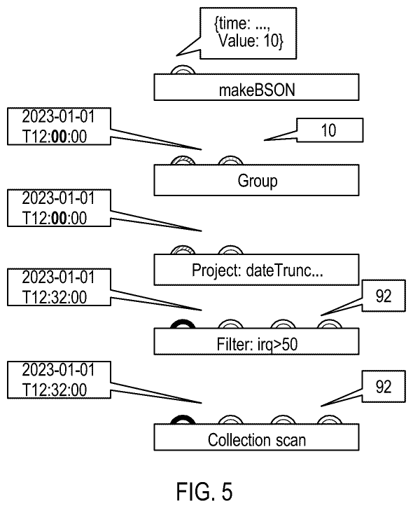

FIG. 5 shows a high-level view of an exemplary scalar pipeline according to some embodiments that processes single values to produce the next result of an aggregate( ) command as requested by the client. In some embodiments, all processing stages consume scalar inputs.

In some embodiments, the initial (lower) part of the pipeline may process not just one value for each invocation of getNext( ) but also may align multiple values and perform the same filter or project operation on all the values at once. Depending on the number of optimizations that could be enabled by this economy of scale, the net effect of running 1 operation on 1,000 closely-packed values will be much less than running 1,000 identical operations on 1 value at the time. For example, “Group”, “Project”, “Filter” are exemplary aggregation pipeline commands for a user requested query that can be optimized by allowing the usage of SIMD instructions.

### Storage/Query Data Access API

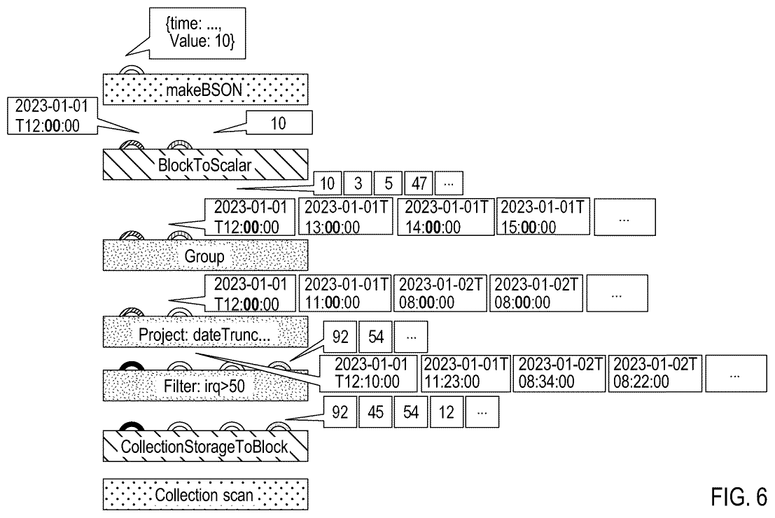

FIG. 6 shows a high-level view of another exemplary pipeline, according to some embodiments. More particularly, FIG. 6 shows a high-level view of an exemplary block processing pipeline according to some embodiments that process time series values in blocks to produce the next result of a query as requested by the client. As shown in FIG. 6, block processing may start with a stage that maps the stored data format into blocks and provides the access interface to the blocks. This mapping/formatting will be discussed in later section in detailing the process the involves the block step-Format BSON Documents into Block Representation 703. In some embodiments, there is one special adapter stage per data source. In some embodiments, a Storage/Query Data Access API, such as ValueBlock Interface, as described below, may be used to access and process values for block processing.

### ValueBlock Interface

In some embodiments, SBE may operate on polymorphic values represented by two separate parts: a TypeTag and a Value. In some embodiments, the TypeTag is an enum that indicates what the value's type is (int, string, BSON object, BinData etc.). In some embodiments, Value is a 64 bit integer whose interpretation depends on the TypeTag. For small values (ints, doubles, small strings), the 64 bits store the value directly. For larger ones (big strings, bin data, Decimal128), the 64 bits store a pointer to a block of memory containing the value.

In some embodiments, ValueBlock is a new C++ interface that represents a sequence of TypeTags and Values with a rich API. Optionally, there are no constraints on what values can live within a ValueBlock. For example, a single ValueBlock may contain both strings and doubles. There are in some embodiments, however, optimized implementations of the ValueBlock interface for common situations, such as when a block has values all of the same type.

In some embodiments, a ValueBlock may not need to store its data in SBE's format. Rather, the data can be BSON, the Time Series format, or a third party format. In some embodiments, the query plan can interrogate the properties of such blocks (block properties) of data without decoding the content. In some embodiments, the definition of the data format is owned by the Storage layer that retrieves it from the archive. In some embodiments, the storage layer may try to implement as many operations as possible on top of the native format, before resorting to converting into the equivalent TypeTag+Value pair.

Below is a simplified version of the ValueBlock interface in some embodiments. In some embodiments, the only operation that must be implemented is extract( ) which may return the contents of the ValueBlock as SBE-native tags and values in Struct-Of-Array form. In some embodiments, the other methods may have default implementations on top of extract( ) or can return a result indicating “I don't know.” These operations will be described in more detail below after other components are described.

```
struct ValueBlock {
  /**
  * API for getting a contiguous run of SBE-natively processable tags and values.
  */
  struct RawTagVals { std::vector<value::TypeTags> tags; std::vector<value::Value> vals;
  };
  virtual RawTagVals extract( ) = 0;
  /**
  * Applies a mapping operation to the block and produces a new block. The mapping
  * operation may describe certain properties about itself, such as whether it is
  * deterministic, whether it is monotonic, whether it acts only on the types.
  */
  virtual std::unique_ptr<ValueBlock> map(ColumnOperation& operation);
  /*
  * These functions return the min/max/first/last if available in O(1) time. Otherwise
  * they return boost::none.
  */
  virtual boost::optional<std::pair<TypeTags, Value>> min( ) = 0;
  virtual boost::optional<std::pair<TypeTags, Value>> max( ) = 0;
  virtual boost::optional<std::pair<TypeTags, Value>> first( ) = 0;
  virtual boost::optional<std::pair<TypeTags, Value>> last( ) = 0;
  /*
  * Returns the count if it's available in O(1) time, otherwise returns boost::none.
  */
  virtual boost::optional<size_t> count( ) = 0;
  /**
  * Returns whether this block contains a ‘Nothing’ value if it's known in O(1) time.
  * A return value of boost::none indicates an answer of ‘maybe’ and requires the
  * caller to check themselves.
  */
  virtual boost::optional<bool> containsNothing Value( );
  /**
  * Returns whether ALL values in the block are contained in the given type
  * set. A missing value/Nothing does not match any of the values in the type set.
  */
  virtual boost::optional<bool> valuesMatchTypeSet(uint32_t bsonTypeMask);
  /*
  * API for converting the block into a tokenized form (ie dictionary compressed).
  */
  struct Token Vec {
  std::vector<int> indexToToken; // Maps index −> token number.
  value::Array tokens; // tokens[i] is the value represented by token i.
  };
  virtual TokenVec tokenize( );
  };
```

FIG. 7 shows a high-level view of another exemplary block diagram of Block Processing Stage 403, according to some embodiments. In some embodiments, the process starts with identifying and/or accessing relevant BSON documents that a user requested to query, block 702. The Block Processing Stage 403 may format the relevant BSON documents into block representation. In some embodiments, an access interface such as ValueBlock interface may be used to access/process values that are formatted in block representation. The process stage 704 may then process a query on the blocks or the values in block representation, or pass them to the next stage, Query Stage 404, for further processing.

### The Document Model and the Cell Representation

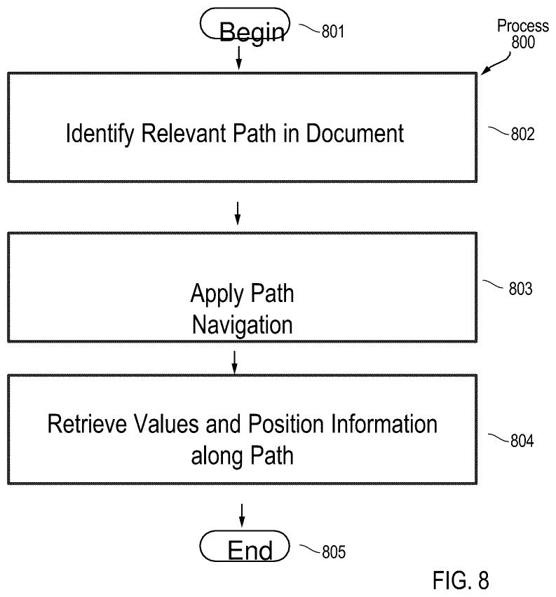

FIG. 8 shows a block diagram of a process for formatting a plurality of BSON documents into one or more blocks, also known as Block Representation, according to some embodiments. In some embodiments, formatting BSON documents into Block Representation entails formatting or representing BSON documents in document or cell representation. In some embodiments, this process may begin with identifying the relevant documents 802. In some embodiments, this step involves identifying one or more documents from the database storage that a user may request to query. Furthermore, in some embodiments, identifying entails identifying the specific fields in the document, or a path in the document.

Some embodiments of block processing pipeline use a “document model.” Although convenient for users, query execution in terms of physical documents may have efficiency drawbacks. Representing the nested structure often requires multiple memory allocations. Documents from the same collection tend to have a common structure and the model of processing one document at a time wastes the opportunity to take advantage of these commonalities.

In some embodiments, ValueBlock is a repository for the data that has to be processed during the execution of a query operator. When the data is comprised of whole documents, however, one of the operations that the query engine may have to perform is a vectorized path navigation 803. In this operation, each item in the block may need to be navigated to obtain the final value that would be placed in the corresponding position in the output block. This operation may traverse arrays during the navigation, generating an array in the corresponding position of the output.

In analytic queries, some embodiments may manipulate flat blocks, both to avoid physical document/array creation and optimize the processing via efficient CPU utilization. For this reason, SBE's block processing primitives may use the Cell Representation in some embodiments. In some embodiments, more particularly, block representation may use the Cell Representation. This alternative model of documents is optimized for batch processing by lifting leaf values into a flat buffer and storing the structural information separately. Some embodiments may map Martin/Svilen's path model onto cells.

In some embodiments, a cell corresponds to one path within one document. A cell may consist of the values at that path and position information indicating where the values are in that document. In the most general case, the position information is equivalent to Mathias's array Info. A simpler, though less compact, representation is used for discussion purposes below with the following exemplary document:

```
{name: ″Alice″,
addresses: [
  {state: ″NY″, zip: 10023, street: ″Broadway″, phone: [″111-111-1111″,
“999-999-9999”]},
  {state: ″CO″, zip: 45678, street: ″Main″, phone: [″222-222-2222″]},
  {state: ″ME″, zip: 04039, street: ″Prospect″, phone:
  [″333-333-3333″]}]}
```

### Cells Via the Path Model

In some embodiments, only a specific path with limited information about the document structure (e.g. $match) may be needed. Using the path model, slices of the document may be described. In an exemplary use case, only “Get” and “Traverse” operations are considered. In some embodiments, the Get operations may represent “getting” a field from a document, and the traverse operations may represent applying the sub-operations to every element in an array, like the one below.

| Path Values | Values |
|---|---|
| Get “name” | Alice |
| Get “address” Traverse Get “state” | “NY” |
| | “CO” |
| | “ME” |
| Get “address” Traverse Get “phone” | [″111-111-1111″, |
| (note no trailing “Traverse”) | “999-999-9999”] |
| | [″222-222-2222″] |
| | [″333-333-3333″] |
| Get “address” Traverse Get “phone” Traverse | ″111-111-1111″, |
| (note how final traverse expands the last array) | “999-999-9999”, |
| | ″222-222-2222″, |
| | ″333-333-3333″, |

### Cells via ArrayInfo

In some embodiments, the information about the structure of a document may need to be preserved and a more general form may be used. In some embodiments, arrayInfo may be used to describe the full structure along the path. In the table above, the cell for the path “addresses.state” contains values [NY, CO, ME] and position information {[{{ } {|} {1}]}. Each pipe| indicates the presence of a value. The open and close brace/brackets indicate objects and arrays. Because there are three state values in this example, there are three pipes. Similarly, the cell for the path “addresses.phone” contains values [“111-111-1111”, “222-222-2222”, “333-333-3333”] and position information {[{[HOHO} }.

For purposes of explanation, the more general arrayInfo form will be used. In some embodiments, however, cells may be described with both a statically described Get/Traverse path, and with arrayInfo. In some embodiments, SBE's block processing, as shown in Block Processing Stage 403, consumes blocks of cells, also known as CellBlock. Consider a block having the following three documents as an example.

```
{name: “Alice”,
addresses: [
  {state: “NY”, zip: 10023, street: “Broadway”, phone:
  [“111-111-1111”]},
  {state: “CO”, zip: 45678, street: “Main”, phone: [“222-222-2222”,
“666-666-6666”]},
  {state: “ME”, zip: 04039, street: “Prospect”, phone: [“333-333-3333”]}
]
}
{name: “Bob”, addresses: [
  {state: “CA”, zip: 44444, street: “Broadway”, phone: [“999-999-9999”,
“444-444-4444”]}
]
}
{name: “Casey”, addresses: [
  {state: “TX”, zip: 55555, street: “Shorter”, phone: [“555-555-5555”]},
  {state: “OK”, zip: 66666, street: “Yellow Brick Road”, phone:
  [“777-777-7777”]}
]
}
```

Applying a path navigation for addresses.state yields a CellBlock that contains all of the (flattened) values at that path, for all of the documents: [“NY”, “CO”, “ME”, “CA”, “TX”, “OK”] with the following position information:

{[{|}{|}{|}]}{[{|}]}{[{|}{|}]}
// Annotated version:
{[{|}{|}{|}]} // First document has three values (three pipes).
{[{|}]} // Second document has one value (one pipe).
{[{|}{|}]} // Second document has two values (two pipes).

In this example, the original block contains three values, while the resulting cell block contains six values. A CellBlock for path addresses.phone in this example contains the following values:

[“111-111-1111”,
“222-222-2222”,
“666-666-6666”,
“333-333-3333”,
“999-999-9999”,
“444-444-4444”,
“555-555-5555”,
“777-777-7777”]

In this example, the strings are simplified for demonstration purposes only. Some embodiments, however, may use a more compact form. If no arrays are present, this information is not needed, and the cell would contain a block with the same number of values as the input block. In some embodiments, The process 800 may end with the step of then retrieving both the values and position information along the whole path in document 804. Thus, a block representation may contain both the values and position information from the documents in a block. In some embodiments, an interface, CellBlock Interface, may be used to run the process 800.

### CellBlock Interface

In some embodiments, the CellBlock interface has two main functionalities: getting all of the values in a flattened form and getting the position information for these values. Because there are different notions of “path” within MQL, different representations for the position information may be optimized for specific path contexts. For purposes of discussion, however, an unoptimized generic representation may be used to recover the full structure of the document that will be used.

```
// Represents a block of values all along a single path.
struct CellBlock {
  // Returns a flat block of scalar values. More on ValueBlock below.
  virtual ValueBlock* getFlatValues( ) = 0;
  // Returns a generic position info string that can be used to reconstruct a
  partial
  // document.
  virtual std::string getGenericPositionInfo( ) = 0;
  // Other functions for getting a simpler form of position info that can be
  used for a
  // specific operation.
  virtual bitset getPositionInfoForFilter( ) = 0;
  virtual bitset getPositionInfoForProject( ) = 0;
};
```

In some embodiments, each data source implements CellBlock and a stage which produces CellBlocks. In some embodiments, data sources will have custom implementations of ValueBlock as well.

Exemplary Implementation of ValueBlock TSBlock

In some embodiments, TSBlock represents the data from a single column in a time series collection. It may be backed by a BSONColumn and exposes the min/max/count summaries available in the control region.

### MonoBlock

In some embodiments, a MonoBlock has just one value, repeated N times. It is a special case of RLE compression. It may be used as the output of a map( ) operation. For example, if map( ) is applied to a ValueBlock of numbers to determine which values are greater than five, and the block contains zero values greater than five, the output may be a sequence [false,false,false,false, . . . , false] represented by MonoBlock (false, N).

### Homogeneous ValueBlock

In some embodiments, all the values in a Homogeneous ValueBlock may have the same type, stored in SBE's value format.

### Heterogeneous ValueBlock

In some embodiments, the values in a Hetrogeneous ValueBlock may be of any type, stored in SBE's value format.

### Validity Map

In some embodiments, it may be necessary to work with “partial” blocks. In some embodiments, this may be done by copying part of a block into a brand new block each time a piece of it is needed, but that may be inefficient. Accordingly, instead of copying the blocks, query plans may keep track of a selection bitmap that indicates which values in the block should be treated as present and which should be ignored. In some embodiments, this ValidityMap is propagated through most SBE block operations. Every operation must check for an all-false ValidityMap before attempting to do real work.

In some embodiments, a ValidityMap may be a special ValueBlock value that contains Boolean values, one for each entry found in the measures being processed. A ValidityMap may be represented using actual bitmaps. In the discussion below, bitmap and ValidityMap are used interchangeably.

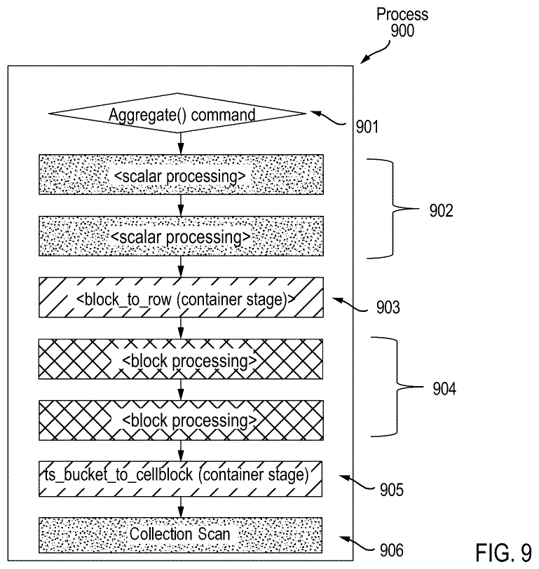

FIG. 9 shows a block diagram of another exemplary execution model, according to some embodiments; More particularly, FIG. 9 shows a high level view of an exemplary aggregate( ) pipeline stages according to some embodiments. The process pipeline 900 may start with receiving an aggregation command from a user 901. In some embodiments, the next stages may process the scalar value per the aggregation command. 902. In some embodiments, such as the one shown in FIG. 9, the pipeline may have sections in the pipeline for block processing of values such as executing the aggregate( ) command on the values.

### Block Processing in SBE

Blocks of data, including certain properties about the blocks and summary info about each block, may be made available to the engine, and processing steps may be performed over them.

### Container Stages

In some embodiments, new stages may be designed so that portions of an SBE plan can be run with block processing, as described above. This yields large improvements even for plans that can't be fully vectorized. In some embodiments, two new “container” stages may be added to SBE to indicate the beginning and end of block processing. In some embodiments, the first new stage, ts_bucket_to_cellblock 905, may be specific to the time series bucket format. The stage takes a time series bucket/data with a set of requested paths and presents the data for each path as a CellBlock to the stages above. Each data source which is deemed suitable for block processing (e.g. columnar storage) may need its own adapter stage in order to present the data format that it uses as a CellBlock.

In some embodiments, the second new stage, block_to_row 903, is generic. This takes as input a bitmap and slots containing blocks and outputs a scalar for each block. This stage unwinds the blocks, presenting them as rows that are decomposed into slots. In some embodiments, values that have a matching False in the bitmap may be skipped. The process 900 may end with a Collection stage 906 that collects all the output scalar values for producing the aggregate( ) command result or for further processing.

FIG. 10 shows a block diagram of an exemplary Query Stage Process, according to some embodiments. More particularly, FIG. 10 shows a high level process of performing query operations on blocks of values. In some embodiment, this process may begin with receiving specific query instructions for a specific block 1002 and determining the relevant blocks 1003, where a user may want to execute a query. In some embodiments, the process then executes the user requested query on the relevant blocks 1004. In some embodiments, query requests may involve filtering, projecting, aggregating values etc, example aspects of the implementation these query are described herein. In some embodiments, this querying is done by using expression language, through the usage of VM Builtins, which is described below in detail.

### New VM Builtins

In some embodiments, a core part of SBE is the expression language, known as EExpression. EExpression is a functional language with a handful of constructs: Constants, variable access, let expressions, binary operations (and, or, equal-to, less than), unary operations (logical not, negation), if/then/else expressions, and function calls. During the plan compilation phase, arbitrary trees of EExpression nodes may be compiled into a bytecode representation that a virtual machine engine can execute just like a real CPU executes assembly instructions. Function calls may be used as an escape hatch into arbitrary C++ code called a builtin. Builtins may take as input N values and return a single value. Builtins may be designed to operate on specific type or types, as shown by the example below:

| Type | Builtins |
|---|---|
| date | dateToString( ), |
| | dateToParts( ), |
| | dateFromString( ) |
| int, long , double, Decimal | abs( ), ceil( ), ln( ), sqrt( ) |
| BSON object | bsonSize( ) |
| sbe::Array, BSON Array | concatArrays( ), |
| | isArrayEmpty( ), |
| | reverseArray( ) |

Just as builtins may be specific to dates and arrays, a number of new builtins that are specific to ValueBlocks and CellBlocks may be added. For ValueBlocks, many of the new builtins are meant to perform an existing scalar operation on all the items of the block by using its interface methods, as illustrated by the table below.

| | Analogous Scalar | |
|---|---|---|
| ValueBlock Builtin | Operation | Explanation |
| valueBlockFillEmpty(valueBlock, | fillEmpty | Fills any Nothing values in the block |
| fill) | | with the “fill” value. For example |
| | | valueBlockFillEmpty(block, |
| | | false) replaces any Nothing values |
| | | with a boolean False value. |
| valueBlockGt(valueBlock, | gt | Returns a block of true/false/Nothing |
| rhs) | | values indicating whether each value in |
| | | the input block was greater than the |
| | | given rhs. |
| valueBlockDateTrunc(bitmap, | dateTrunc | Given a block of dates, truncates each |
| valueBlock, | | one based on the given arguments. |

| | | |
|---|---|---|
| timezone, | | |
| unit, | | |
| ...) | | |
| valueBlockMap(bitmap, | <None> | This function takes a block and a |
| block, | | callback, in the form of an SBE lambda |
| callback) | | EExpression. It applies the lambda to |
| | | each element of the block and returns a |
| | | new block with the results. |
| | | valueBlockMap( ) is used as a fallback |
| | | when there is no block-specific variant of |
| | | a scalar builtin. For example, to a apply a |
| | | regex to each value in a block without |
| | | adding a new valueBlockRegex builtin, |
| | | we could do: |
| | | valueBlockMap (block, |
| | | (v) −> applyRegex (v) ) |
| valueBlockMin(bitmap, block) | <None> | Returns the minimum value in the block |
| | | where the corresponding item in the |
| | | bitmap is True. If the bitmap is made of |
| | | all TrueS, and ValueBlock implements |
| | | the constant-time min( ) function, that may |
| | | be used. Otherwise the minimum value |
| | | will have to be computed. |
| valueBlockNew(value, size) | <None> | Returns a new block made of <size> |
| | | items all set to the value <value> |
| valueBlockSize(block) | <None> | Returns an integer value representing the |
| | | number of items contained by the block |

| | Analogous | |
|---|---|---|
| CellBlockBuiltin | Scalar Operation | Explanation |
| cellBlockGetFlatValues(cellBlock) | <None> | Takes a CellBlock and returns the |
| | | values in that CellBlock in a flattened |
| | | ValueBlock. |
| cellBlockGetGenericPositionInfo(cellBlock) | <None> | Takes a CellBlock and returns the |
| | | generic position info, as a string. |
| cellBlockGetFilterPositionInfo(cellBlock) | <None> | Takes a CellBlock, and returns a simpler |
| | | position info string that does not have |
| | | enough information to reconstruct the |
| | | entire document structure, though it can be |
| | | used for filtering. |

| | Analogous | |
|---|---|---|
| Bitmap Builtin | Scalar Operation | Explanation |
| bitmapNone(bitmap) | <None> | Returns True if none of the values in |
| | | the bitmap are set to the boolean value |
| | | True, False otherwise. |
| bitmapAnd(bitmap1, bitmap2) | <None> | Returns a new bitmap with True values |
| | | in the position where both arguments |
| | | have a True value, False otherwise |
| bitmapNot(bitmap) | <None> | Returns a new bitmap with False |
| | | values in the position where the |
| | | argument had a True value, True |
| | | otherwise |

ValueBlock::map( ) and ColumnOperation

In some embodiments, an important API on ValueBlock is the map( ) function. This is a standard operation in most programming languages: given a collection of values and a lambda, the operation applies the lambda to each member of the collection and produces a new collection with the results. ValueBlock::map( ) takes a ColumnOperation, essentially a “rich lambda,” instead of a standard C++ lambda.

This ColumnOperation may be defined as set forth below:

| | |
|---|---|
| /* | |
| * | Set of callbacks for applying an operation to a block. Offers callbacks for |

running

| | |
|---|---|
| * | the operation on a single value, 8-32 vals, or n values. |

*/
struct ColumnOperation {

| enum Info : int8_t { | |
|---|---|
| kDeterministic = | |
| 1 << 0, | // operation executed on identical arguments yields |
| | // identical result |
| kMonotonic = 1 << 1, | // operation executed on an argument of increasing |
| values | |
| // always yields either a greater or a lesser result kOwnResult | |
| = 1 << 2, | // result must take ownership of the returned |

values kIgnoreValue = 1 << 3, // report only the type of the cell, value is not
used kHasSideEffects = 1 << 4, // invoke the callback exactly once per enabled
value, even
// if it could be avoided

};

```
  using BasicOperation = std::function<std::pair<value::TypeTags,
  value::Value> ( size_t index, value::TypeTags tag, value::Value
  value)>;
using Batch8Operation = std::function<void(size_t startIndex,
```

```
  value::TypeTags
  tag,
  value::Value
  values[8],
  value::TypeTags
  outTags[8],
  value::Value
  outValues[8])>;
```

using Batch16Operation = std::function<void(size_t startIndex,

```
  value::TypeTags
  tag, value::Value
  values[16],
  value::TypeTags
  outTags[16],
  value::Value
  outValues[16])>;
```

using Batch32Operation = std::function<void(size_t startIndex,

```
  value::TypeTags
  tag, value::Value
  values[32],
  value::TypeTags
  outTags[32],
  value::Value
  outValues[32])>;
```

using BatchOperation = std::function<void(size_t startIndex,

size_t length,
value::TypeTags
tag,
value::Value*
values,
value::TypeTags
* outTags,
value::Value*
outValues)>;

int8_t flags = 0;
BasicOperation
basicOperation;
Batch8Operation
batch8Operation;
Batch16Operation
batch16Operation;
Batch32Operation
batch32Operation;
BatchOperation
batchOperation;

In some embodiments, ColumnOperations may be invoked with a single value, or they may be invoked on a contiguous buffer of values having the same TypeTags, which in turn, may invoke specialized versions accepting exactly 8, 16, or 32 values at once. This approach allows amortization of the cost of indirect calls, but may also allow the usage of SIMD instructions and any low-level optimization that the C++ compiler can perform when it compiles a loop repeating the same operation, for a number of times known at compilation time, on values placed in a contiguous area of the memory.

As an example, the block-enabled $gt operation may be implemented by means of a SIMD-enhanced valueBlockGt, that detects the case when the operation is comparing a block against a constant double, and routes the comparison between a contiguous buffer of double values inside the block towards a routine doing comparison of double values using the XSIMD library in order to process multiple items at a time. Depending on the availability of wider registers on the CPU, the operation could process 2 (by using SSE2's 128 bit registers), 4 (by using AVX2's 256 bit registers) or 8 (by using AVX-512's 512 bit registers) double values at a time.

```
template <size_t COUNT>
void compareWithDouble(TypeTags tag, Value values[COUNT], TypeTags outTags[COUNT], Value
outValues[COUNT], TypeTags rhsTag, Value rhsVal) {
  if (tag == TypeTags::NumberDouble) {
    for (size_t i = 0; i < COUNT; i++)
      { outTags[i] =
      TypeTags::Boolean;
    }
    xsimd::batch<double> rhs = bitcastTo<double>(rhsVal);
    for (size_t i = 0; i < COUNT; i += xsimd::batch<double>::size) {
      auto lhs =
      xsimd::batch<double>::load_unaligned(reinterpret_cast<double*>(values +
i));
      auto res = lhs > rhs;
      auto boolres =
      xsimd::bitwise_cast<int64_t>(xsimd::batch_bool_cast<int64_t>(res));
      boolres.store_unaligned(reinterpret_cast<int64_t*>(outValues + i));
    }
  } else {
    for (size_t i = 0; i < COUNT; i++) {
      std::tie(outTags[i], outValues[i]) = genericCompare<std::greater<>>(tag,
values[i], rhsTag, rhsVal);
    }
  }
}
FastTuple<bool, TypeTags, Value> ByteCode::builtinValueBlockGt(ArityType arity) {
...
  if (valueTag ==
    TypeTags::NumberDouble) {
    ColumnOperation operation(
      ColumnOperation::Info::kMonotonic |
      ColumnOperation::Info::kDeterministic, [&](size_t index, TypeTags tag,
      Value value) {
          return genericCompare<std::greater<>>(tag, value, valueTag, valueVal);
      },
.../* callbacks for 8 and 16 items reusing the template above */
      [&](size_t startIndex, TypeTags tag, Value values[32], TypeTags
outTags[32], Value outValues[32]) {
        compareWithDouble<32>(tag, values, outTags, outValues, valueTag,
        valueVal);
      });
    auto res = blockView−>map(operation);
    return {true, TypeTags::valueBlock, bitcastFrom<ValueBlock*>(res.release( ))};
  } else {
.../* setup a ColumnOperation that only provides the callback operating on a single
value */
  }
}
```

In some embodiments. ColumnOperations may also allow the query system to annotate the callback with certain block properties. The ValueBlock's implementation may often take advantage of these properties, depending on the data layout.

| | | Example ColumnOperation with this |
|---|---|---|
| Property | Explanation | Property |
| kDeterministic | The callback guarantees that it will | // Determine whether each value in the |
| | not access any other global | // block is even or odd. |
| | information and will only consider | valueBlock.map(lam(x) => x % 2 == 0) |
| | the value provided in input. It will | |
| | also ignore the position of that | |
| | value inside the block. | |
| | When this is set, the callee may | |
| | be able to apply the lambda fewer | |
| | times. For example, if the data is | |
| | dictionary or RLE compressed, | |
| | the lambda only has to be called | |
| | for each token, or each run. | |
| kMonotonic | Function is entirely | lam (x) => x > 5 is a monotonic |
| | non-increasing or entirely | function, as well as >=, <, <= |
| | non-decreasing. | lam (x) => x == 5 is NOT a |
| | If the ValueBlock can provide | monotonic function (going from −inf |
| | min and max summaries, a | to +inf, it assumes values False, |
| | monotonic function can be first | True, False) |
| | applied to the boundaries. If | lam (x) => x ⇔ 5 is a monotonic |
| | f (min) == f (max) then the | function (going from −inf to +inf, it |
| | result for the entire block is | |

| | | |
|---|---|---|
| | f (min). | assumes values −1, 0, +1) |
| | If the ValueBlock is sorted, | lam (x) => truncate (x) is also |
| | applying a map( ) operation with a | monotonic, when x is always of the |
| | monotonic callback can use | same sign, including 0. |
| | binary search, treating each | |
| | subsegment of the block as | |
| | having the minimum value in the | |
| | first position and the maximum | |
| | value in the last position, and | |
| | using the previous rule. | |
| kIgnoreValue | The callback doesn't care about | // Any kind of type checking operation |
| | the value it's passed, only the | // can use this flag, e.g: |
| | type. | lam (x) => type (x) == int |
| | If a ValueBlock is storing data | |
| | which all has the same type, and | |
| | the callback is also reported as | |
| | being kDeterministic, | |
| | ValueBlock::map( ) could | |
| | invoke the callback just once on | |
| | a random item of the block. | |

### Using the Primitives in a Primitive Way Applying Filters

In some embodiments, with scalar execution, filtering may be applied by inserting a stage in the pipeline that executes a predicate expression (represented by a tree of EExpression primitives) and only if that expression returns a positive result, the control is passed to the caller stage. Otherwise, the filter stage will request a new candidate row from its source stage and repeat the evaluation.

With block processing, the predicate is evaluated in chunks, so the output of the filter stage is actually a bitmap indicating the passing entries in the block.

Below is an exemplary SBE plan for the filter s1>0 AND s1==5:

| Scalar Form | Block Form |
|---|---|
| filter s1 > 0 && slot2 == 5 | // block_to_row “hides” the elements with |
| // Assume s1 and s2 contain scalars. | // a corresponding 0 in the bitmap. |
| | block_to_row in[s1, s2] out[s3, s4] bitmap |
| | project bitmap= |

```
  valueBlockAnd(
    valueBlockGt(s1, 0),
    valueBlockEq(s2, 5))
// Assume s1 and s2 contain ValueBlocks.
```

### Projecting Computed Values

In scalar execution, in some embodiments, values are computed inside the projection stage that reads a number of scalar inputs and produces, by means of EExpression primitives, new scalar outputs to be consumed by the caller stage. In block processing, the values processed by the projection stage are a mix of scalar and block types, provided that all the block types have the same number of items.

Below is an exemplary SBE plan for projecting the sum of numbers in s1 and s2:

| Scalar Form | Block Form |
|---|---|
| Project sum = s1+s2 | project sum=blockValueAdd(s1, s2) |
| // Assume s1 and s2 contain scalars. | // Assume s1 and s2 contain ValueBlocks. |

For an operation that has no valueBlock*specific counterpart, the valueBlockMap builtin may be used and called into the scalar code. For example, the square root of s1 may be computed and the result may be stored in s2:

| Scalar Form | Block Form |
|---|---|
| Project s2 = sqrt(s1) | project s2=blockMap(s1, |
| | lam(x) −> sqrt (x)) |

This would not perform as well as a block-specific blockSqrt( ) function, because the VM is now being invoked once per value, rather than once per block. Nonetheless, in some embodiments, this tradeoff may be acceptable for less commonly used expressions.

### Aggregations

The term “Aggregation” as used below refers to the concept generally understood in Database Engines, not the pipeline construct in MQL (MongoDB Query Language). In some embodiments, block processing offers the biggest advantage with aggregating data. For eligible aggregation functions, a partial aggregation on the block may be computed, and then merged with a running aggregation for the entire data set. A similar process may be used for aggregations on sharded collections: a partial aggregate is computed on each shard, then combined on the merging node. The same pattern may be used for aggregations which spill. For example, with a count operation, a partial count may be computed for each group within the block, and then the counts seen across blocks may be added.

This logic may encapsulated in a new block group stage as set forth below:

block_hashagg groupBySlot bitmap [blockAgg1, blockAgg2, ...]
[mergeExpr1, mergeExpr2, ...]

For example, for a collection of “sales” and group by state, computing the count (number of sales per state), the maximum dollarAmount (largest sale per state), and sum of dollarAmount (total revenue per state), may be expressed via:

```
block_hashagg key=stateSlot bitmap=<AllOnesBitmap>
  // Block-level aggregations. These happen
  first. [sum(1), // sum(1) is how we express
  count( ). blockMax(bitmap, dollarAmount),
  blockSum(bitmap, dollarAmount)]
  // Merge expressions. These describe how to merge partial
  // aggregations computed for each block.
```

| | |
|---|---|
| [sum(x), | // Add up the counts we computed within each block. |
| max(x), | // Take the max( ) of the max value computed |
| | // within each block. |
| sum(x) | // Add up the sum of dollar amounts computed within |
| | // each block. |

]
// stateSlot contains a block of states
// dollarAmountSlot contains a block of numbers
indicating how much each
sale was for.

Internally, the block_hashagg function may use the tokenize( ) method on the key's ValueBlock to partition the values. This can be optimized for common cases, like when the group-by key is the same for the entire block, or if the group-by key block is stored in an RLE or dictionary compressed form.

Non-algebraic accumulators (e.g. median) may be computed based on the complete group. The intermediate steps such as sort may be partitioned and vectorized.

In Some embodiments, the process of 1000 may end with generating one or more output arrays responsive to the query on relevant blocks in step 1005. In some embodiments, the array may need further unwinding.

### Unwinding an Array

Some embodiments include another common operation of unwinding an array. In some embodiments, this may be expressed with the cell representation. In some embodiments, the block representation uses cell representation. This common operation will be described by first using an example with a document form and second using an example with a cell form. Suppose we have the following “documents” and want to unwind the addresses field and that we're interested in counting the total number of people who live on a street called “Broadway.”

### Before Unwind:

```
{name:
  “Alice”,
  addresses:
  [
      {state: “NY”, zip: 10023, street: “Broadway”},
      {state: “CO”, zip: 45678, street: “Main”},
      {state: “ME”, zip: 04039, street: “Prospect”}]}
{name:
  “Bob”,
  addresses:
  [
      {state: “CA”, zip: 44444, street: “Broadway”}]}
{name”
  “Casey”,
  addresses:
  [
      {state: “TX”, zip: 55555, street: “Shorter”},
      {state: “OK”, zip: 66666, street: “Yellow Brick Road”}]}
      After Unwind:
    {name: “Alice”, addresses: {state: “NY”, zip: 10023, street: “Broadway”}}
    {name: “Alice”, addresses: {state: “CO”, zip: 45678, street: “Main”}}
    {name: “Alice”, addresses: {state: “ME”, zip: 04039, street: “Prospect”}}
    {name: “Bob” addresses: {state: “CA”, zip: 44444, street: “Broadway”}}
    {name: “Casey”, addresses: {state: “TX”, zip: 55555, street: “Shorter”}}
    {name: “Casey”, addresses: {state: “OK”, zip: 66666, street: “Yellow Brick Road”}}
```

For the example with the cell representation, the “name” CellBlock and the “addresses.state” CellBlock may be used because cells work in terms of leaf values. The same logic may be applied to the other paths as well.

### Before Unwind:

Name positionInfo

| | | Addresses.state | Address.state |
|---|---|---|---|
| Name values | Name positionInfo | values | positionInfo |
| [“Alice”, | { \| } | [“NY”, | {[{ \| }{ \| }{ \| }]} // |
| | | | Alice |
| “Bob”, | { \| } | “CO”, | |
| “Casey”] | { \| } | “ME”, | |
| | | “CA”, | {[{ \| }]} // Bob |
| | | “TX”, | {[{ \| }{ \| }]} // |
| | | | Casey |
| | | “OK”] | |

An “unwind” operation may be applied to “address.” For all cells that are a subfield of “address” (e.g., “address.state”), it is determined whether “address” is an array, and if so, each element of that array is hoisted into its own “document.” For example, the “address.state” field in Alice's document:

For fields unrelated to “address,”, the value and position info are duplicated once for each array Item to yield:

| | Name position | | Address.state |
|---|---|---|---|
| Name values | info | addresses.state | position info |
| [“Alice”, | { \| } | [“NY”, | {{ \| }} |
| “Alice”, | { \| } | “CO”, | {{ \| }} |
| “Alice” | { \| } | “ME”, | {{ \| }} |
| “Bob”, | { \| } | “CA”, | {{ \| }} |
| “Casey”, | { \| } | “TX”, | {{ \| }} |
| “Casey”] | { \| } | “OK”] | {{ \| }} |

Applying unwinding operations on cells is much faster than applying them to physical documents. There's no need to allocate space for new fields or to walk the document's structure. Furthermore, most of the string manipulations shown here with the verbose position info will be simpler with the optimized implementation.

For example, the position info for “address.state” in the Alice document: {[{|}{|}{|}]}

On a sub-path which does not go through any arrays, there can be only one value. So the last opening {'s may be treated as implicit: {[∥|

The {indicates the root object. The [indicates that “address” is an array. Now, if in this example, a | can infer that all remaining elements on the path are objects. The post-unwind version can also be shortened in the same manner:
{{|}}{{|}}{{|}}

First, the closing} can be inferred, since there can be only value within a series of {uninterrupted by a [

{{|{{|{{|

A series of opening {can be stored “implicitly” by the fact that there is no [. This means we could represent the same thing with: III

In some embodiments, additional techniques in array Info (Mathias Stearn) encoding may be used as well.

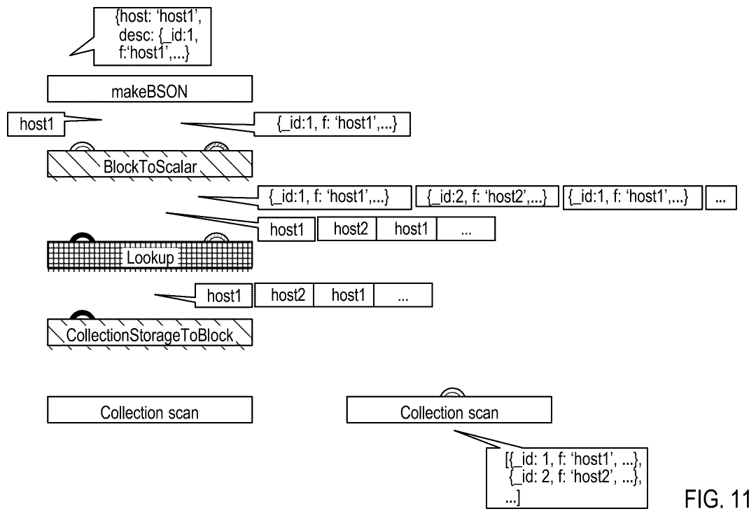

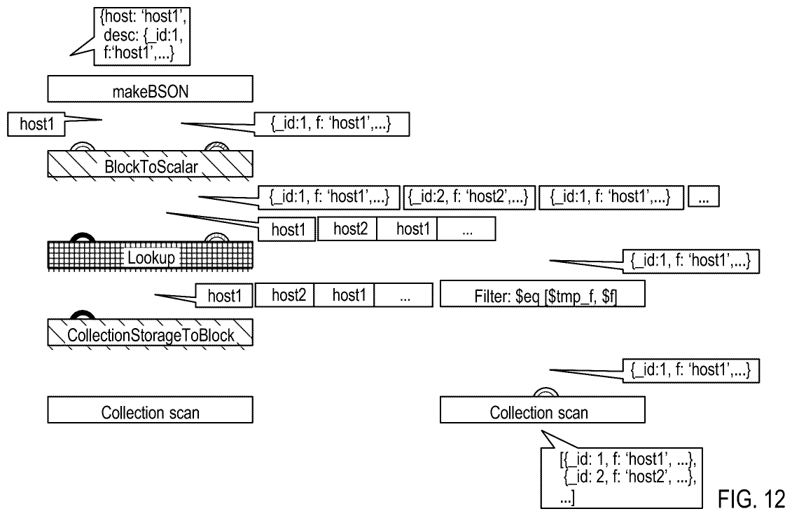

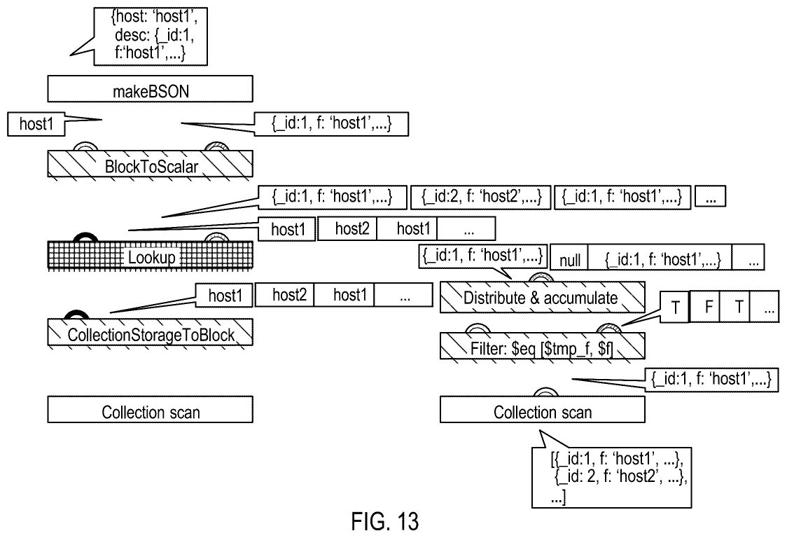

FIG. 11-13 show high-level views of exemplary pipelines, according to some embodiments. More particularly, FIG. 11-13 show high-level views of a pipeline that involves hash lookup functions using various embodiments.

### Hash Lookup

In some embodiments, a hash join operation may be applied with blocks. A block_hash_lookup stage may be constructed to consume block values on either side of the operation. If the lookup is in the simple format $lookup: {from: <coll>, localField: <field>, foreignField: <field>, as: <target_field>}, blocks in either the local field or the foreign field may be found.

When the build side is provided as blocks, the hash table can be populated as usual, iterating over all the items in the block (e.g. using extract( ) to get them in one contiguous block), and computing their hash value to organize them for quick lookup. In this way, the case when the collection has multiple documents for the same key can be handled correctly.

When the probe side is provided as blocks, the hash value and the result of the probe operation can instead be optimized to reduce the number of lookups using the map( ) interface method. The (deterministic) callback function will compute the hash value and return an array of values taken from the hash table entry associated with the key. In case the block has RLE or dictionary compressed data, the callback would be called only once per distinct value, and the result of the (single) probe would be cloned for all the identical values in the resulting block output, that would be immediately generated in the output slot of the stage.

If the lookup is reading the data using a user-provided pipeline, e.g. $lookup: {from: <coll>, let: {<tmp_field>: <local_expr>, . . . }, pipeline: . . . , as: <target_field>}, the pipeline can fallback into the previous case if the pipeline is uncorrelated and can be read (and hashed) only once. If the pipeline is correlated with the current probe value in a custom way that doesn't allow the creation of a hash-based equality, the pipeline can define how to handle the case when the local collection is producing the data in blocks.

In this scenario, the (possibly multiple) local_expr are block of values that are generated similarly to what a $project stage would do; from this point the stage would iterate sequentially (from index I up to the size of the block) over all the corresponding values of those expressions, bind the current item to each temporary field and then invoke the child pipeline once to retrieve the value to be put in the corresponding value of the block stored in the target_field slot.

With this approach, the pipeline would be producing a single value for each clock cycle, and would work for both standard and block-producing foreign collections. In the latter case the compiled pipeline would end with a BlockToScalar stage at the top, whose output would then be accumulated into the array representing the result of the lookup operation.

In some embodiments, this scenario from above, may be vectorized by treating the tmp_field as block variables instead of unrolling them into scalar values such that attempting to use the block of probe values against the current foreign document would yield a mask of boolean values indicating which probe values should use the current value. In some embodiments, this mask would be used to accumulate the current document into the correct result array. This approach would read the foreign collection only once, and test every value against the N items of the probe block, compared to the previous approach that would read the foreign collection N times, testing each value with just one probe value at a time.

### Sort

In some embodiments, for the initial set of operations to be supported, $top/$bottom are included. In some embodiments, a user specified sort may be supported with established algorithms to efficiently compute in memory (partial) sort as well as merging, if the data type is fixed and known.

Expressing MQL Semantics Using the valueBlock*primitives

In the SBE engine of some embodiments, the MQL expressions that are part of the find( )/aggregate( ) commands provided by the client applications may be implemented by means of primitives of a VM that don't perform any extra operation under the hood, e.g. automatic type conversions to be able to compare an array with a string value. These extra rules may be injected as extra primitives during the compilation of the plan, either to pre-process the arguments of the operation or to post-process its result.

### Expression Vectorizer

In the SBE engine of some embodiments, if the plan makes use of the block-enabled stages, an EExpression tree reading data from a slot holding a ValueBlock object may be converted into a new tree where the VM primitives are replaced with the corresponding block-oriented ones; failing that, a block_to_row stage needs to be inserted into the compiled pipeline and the tree modified to reference the scalar slot corresponding to the original one. The generation of the new tree can be done by a rewrite rule that walks the original tree and generates the new one in a bottom-to-top walk. These are the rules for processing each node that can be encountered; the placeholder <block_expr> indicates any node that is either a reference to a variable holding a ValueBlock object, or a function call defined as returning a ValueBlock object as its result. For some of them there will be multiple conversion rules to handle the cases where the arguments of the operation are scalars or blocks.

| Original node | Vectorized node |
|---|---|
| Constant | Unchanged |
| Reference to a variable holding a | Unchanged |
| scalar value | |
| Operation on scalar values (constants | Unchanged |
| or variable references) | |
| fillEmpty(<block_expr>, replacement) | valueBlockFillEmpty(<block_expr>, replacement) |
| typeMatch(<block_expr>, type_mask) | valueBlockTypeMatch(<block_expr>, type_mask) |
| exists(<block_expr>) | valueBlockExists(<block_expr>) |
| isDate\|isString\|isNumber\|isArray(<block_{—} | valueBlockTypeMatch(<block_expr>, |
| expr>) | date_type_mask\|string_type_mask\|number_type_mask\|array_type_{—} |
| | mask) |
| coerceToBool(<block_expr>) | valueBlockCoerceToBoo\|(current_mask, <block_expr>) |
| <block_expr> [gt\|gte\|eq\|neq\|lte\|lt\|cmp3w] | valueBlockGtScalar/valueBlockGteScalar/valueBlockEqScalar/ |
| scalar_value | valueBlockNeqScalar/valueBlockLteScalar/valueBlockLtScalar/ |
| | valueBlockCmpScalar(<block_expr>, scalar_value) |

| | |
|---|---|
| <block_expr1> | valueBlockGtBlock/valueBlockGteBlock/valueBlockEqBlock/ |
| [gt\|gte\|eq\|neq\|lte\|lt\|cmp3w] | valueBlockNeqBlock/valueBlockLteBlock/valueBlockLtBlock/ |
| <block_expr2> | valueBlockCmpBlock(<block_expr1>, <block_expr2>) |
| <block_expr1> and <block_expr2> | Let mask = <block_expr1> in |
| | valueBlockAnd(mask, applyMask(mask, <block_expr2>)) |
| <block_expr1> or <block_expr2> | Let mask = <block_expr1> in |
| | valueBlockOr(mask, |
| | applyMask(bitmapNot(valueBlockFillEmpty(mask, False)), |
| | <block_expr2>)) |
| <block_expr> [+\|−\|*\|/] <scalar_expr> | valueBlockAdd/valueBlockSub/valueBlockMul/valueBlockDiv(current_{—} |
| | mask, <block_expr>, scalar_value) |
| <block_expr1> [+\|−\|*\|/] <block_expr2> | valueBlockAddBlock/valueBlockSubBlock/valueBlockMulBlock/ |
| | valueBlockDivBlock(current_mask, <block_expr1>, <block_expr2>) |
| dateDiff(<block_expr>, <scalar_expr>, | valueBlockDateDiff(current_mask, <block_expr>, <scalar_expr>, |
| unit, timezone, start_of_week) | unit, timezone, start_of_week) |
| dateDiff(<block_expr1>, <block_expr2>, | valueBlockDateDiffBlock(current_mask, <block_expr1>, |
| unit, timezone, start_of_week) | <block_expr2>, unit, timezone, start_of_week) |
| dateTrunc(<block_expr>, unit, binSize, | valueBlockDateTrunc(current_mask, <block_expr>, unit, binSize, |
| timezone, start_of_week) | timezone, start_of_week) |
| dateAdd(<block_expr>, unit, +/− amount, | valueBlockDateAdd(current_mask, <block_expr>, unit, +/− amount, |
| timezone) | timezone) |
| If (<block_expr>) | If (<block_expr>) |
| Then scalar_expr1 | Then valueBlockNew(scalar_expr1, valueBlockSize(<block_expr>)) |
| Else scalar_expr2 | Else valueBlockNew(scalar_expr2, valueBlockSize(<block_expr>)) |
| If (<block_expr>) | If (<block_expr>) |
| Then <block_expr1> | Then <block_expr1> |
| Else scalar_expr | Else valueBlockNew(scalar_expr, valueBlockSize(<block_expr>)) |
| If (<block_expr>) | If (<block_expr>) |
| Then scalar_expr | Then valueBlockNew(scalar_expr, valueBlockSize(<block_expr>)) |
| Else <block_expr2> | Else <block_expr2> |
| If (<block_expr>) | Let mask = valueBlockFillEmpty(<block_expr>, False) in |
| Then <block_expr1> | valueBlockCombine(applyMask(mask, <block_expr1>), |
| Else <block_expr2> | applyMask(bitmapNot(mask), <block_expr2>), |
| | mask) |
| max(<block_expr>, . . . ) | valueBlockMax(current_mask, <block_expr>, . . . ) |
| min(<block_expr>, . . . ) | valueBlockMin(current_mask, <block_expr>, . . . ) |

| | |
|---|---|
| operation(<scalar> . . . , <block_expr>, | valueBlockApplyLambda(current_mask, <block_expr>, lam(x) => |
| <scalar> . . . ) | operation(<scalar> . . . , x, <scalar> . . . )) |

In this example, The valueBlockCombine instruction generates a new block having the same size of the input arguments (that must be identical for all of them), in which each item is either the corresponding item in the first argument if the mask argument has a True value in the same position, or the item in the second argument if otherwise. In some embodiments, the “applyMask” instruction is a virtual operation that works inside the vectorizer itself, setting up a current_mask that will be added to any operation that accepts a mask as its first argument, wherein the mask is meant to restrict the operation scope to only the positions in the block that have a matching value of True in the mask. Every operation accepting a mask should short circuit the execution if the mask contains all False values. As enforcing a mask in the operation callback would make the operation no more deterministic (as the callback would also keep into consideration the position of the value inside the block, and not just the tag+value to operate on), and hence require the operation to be invoked on all the values of the block regardless of whether they were identical, the operation could in some cases opt to ignore the mask and work on the entire block (e.g. if a majority of True values are present in the mask).

The list of operations that accept the mask as their first argument are those which:
1. Can report a query-aborting error during their execution, and should do it only if the
value triggering it is at a selected position (example, overflow in addition/subtraction/multiplication and division by 0, coercion of an unsupported data
type to boolean); or
2. Are costly operations, and should be attempted only if strictly necessary.

If the plan compilation arrives at a point where it has to generate VM code using primitives that don't expect a mask (e.g. valueBlockExists) on top of slots that haven't been processed yet, it can still try to avoid an unnecessary block decompression operation when the mask is completely unset by wrapping the operation in a
if (bitmapNone (current_mask))
then valueBlockNew (Nothing, valueBlockSize (current_mask))
else valueBlockGt (<block_expr>, scalar)

When the node is detected to return a CellBlock value, the following rules will be applied:

| Original node | Vectorized node |
|---|---|
| <cell_expr> | cellBlockGetFlatValuesBlock(<cell_expr>) |
| traverseF(<cell_expr>, lam(x) => lambda(x), | cellFoldValues_F(lambda(<cell_expr>), <cell_expr>) |
| False) | |
| traverseP(<cell_expr>, lam(x) => lambda(x), 1) | cellFoldValues_P(lambda(<cell_expr>), <cell_expr>) |

The first rule will ensure that the type of the result will be a ValueBlock object that can be manipulated by the primitives listed in the first table.

The second rule takes care of ensuring that the evaluation of the lambda on the flattened values is then folded back into a ValueBlock having the expected number of items, using the folding rule for boolean predicates (values from the same level will generate a single True/False value depending on whether there is at least a True value among them)

The third rule is similar to cellFoldValues_F, but uses the folding rule for the projection of values (all values from the same level will be placed in an array value).

### Lazy Error Handling

In some embodiments, only a subset of pipelines may be enabled for block processing, there could be a case where the user requests the execution of a query just to cancel it after the first batch of results has been returned, either because the client cursor is never advanced, or because of the presence of a $limit instruction after the scalar section of the pipeline. In this case, it would be beneficial not to report an error as soon as it is detected in the block operation, but rather wait until the value is promoted to be a user-visible result. In order to achieve that, a new TypeTags enum, “error,” whose content is a pair of an error code and a string description, may be introduced. This value can be produced by the fail instruction when executed in a block-enabled processing pipeline, and internally inside a ValueBlock by operations hitting conditions such as overflow or division by 0.

### The Path Model and Cells

In some embodiments, the new optimizer and SBE are based on path model (Martin Neupauer) which decomposes

MQL's path semantics into smaller, more intuitive operations. While the path model is described in terms of documents with a nested structure, it can be applied to cells as well.

In SBE, path traversals are applied using the traverseF( ) and traverseP( ) operations. Traverse expressions walk a path within a document, apply a callback to each value, and then combine the results. With traverseF( ) the results are combined via a logical OR. With traverseP( ) the results are combined into an output array containing the values that were visited. Since the cell model separates the values from the structural information, we cannot reuse traverseF( ) and traverseP( ) We therefore apply operations to the values separately (TODO) Instead, we apply the callback to the entire block, and then resolve the position information afterwards in a step called “folding.” The specifics of the “fold” operation depend on the path context. We currently have two fold operations: foldF (akin to traverseF) and foldP (akin to traverseP).

For example, {$match: {“a.b.c”: {$gt:123}}} would be expressed by:

block_to_row blocks[s10, s11, s12] vals[s16, s17, s18] s15
project [s15 = foldValues_F(valueBlockFillEmpty(valueBlockEq(s14, 123L), false),
s13))]
project [s14 = cellBlockGetFlatValueBlock(s13)]
// Put CellBlocks for _id, a, time and a.b.c into slots.
ts_bucket_to_cellblock s7 paths[s10 = _id, s11 = a, s12 = time, s13 = a.b.c] meta =
s9
// Collect the BSON buckets from storage. This could be via collection scan,
// ixscan/fetch, we could read from S3, etc. scan
bson=s7 rid=s8 [s5 = meta, s6 = control]

### Using Cells

By separating the values from the information about the document's structure, it becomes easy to do operations on values deep within a complicated document structure. For example, in order to find customers who have a phone number starting with 222, the system pipeline can take the CellBlock for addresses.phone, extract the flat ValueBlock from it, and compute a bitmap indicating whether each phone number starts with “222”:

| | |
|---|---|
| [“111-111-1111”, | [0, |
| “222-222-2222”, | 1, |
| “666-666-6666”, | 0, |
| “333-333-3333”, | 0, |
| “999-999-9999”, | 0, |
| “444-444-4444”, | 0, |
| “555-555-5555”, | 0, |
| “777-777-7777”, | 0] |

The pipes then can be substituted (|) in the position info with the 1s and 0s:
{[{[0][10][0]}]}{[{{[00]}]}{[{[0][0]}]}

In this example, an operation can be applied that logically ORs the values within a single document.

(Logical OR because the customers that are preferred where ANY of their phone numbers start with 222):

{[{[0][10][0]}]} → 1
{[{[00]}]} → 0
{[{[0][0]}]} → 0

This indicates that only the first customer, Alice, has a 222 phone number. It is appreciated that the foregoing example is provided for purposes of illustration only and does not necessarily reflect a practical implementation, but similar thinking can be applied to real-world use cases. Applying a predicate (e.g. $match), collecting all of the values at a path (ExpressionFieldPath) can both be expressed with this model.

Similarly, operations can work across “documents” or blocks like unwinding an array ($unwind).

For example, if the aim is to unwind addresses.phone and get a flat list of “documents” each containing one phone number, it can be done by this transformation by just changing the position information, and not touching the values at all.

### Detailed Example Query and SBE Plan

An example aggregation pipeline is described herein, that computes the max CPU usage of two hosts across intervals of 5 minutes:

```
aggregate([
{$match: {
  “measurement”: ″cpu″,
  ″tags.hostname″: {$in: [″host_0″, ″host_1″]}
  }
},
{$group: {
  _id: {$dateTrunc: {date:″$time″, unit:″minute″, binSize: 5}},
  ″max_cpu″: {$max: ″$cpu″}
  }
}
])
```

Here is the SBE plan generated for a plain collection having the same structure of the time series repository; it has the same structure of the scalar plan executed on top of a hypothetical BucketUnroll stage.

The plan assumes that the parameters are stored in these global slots:

s1 = TimeZoneDatabase(America/Martinique...America/Creston)
(timeZoneDB)
s11 = [″host_0″, ″host_1″]
s10=”cpu”

These are the stages needed to ensure the adherence to the MQL semantics while performing path navigation and data aggregation:

```
  ...
  [2] project [s12 =
  ( let [
      l101.0 = dateTrunc(s1, s5, “minute”, 5L, “UTC”, “sun”)
  ]
  in
      if
      exists(l101.0)
      then
      move(l101.0)
      else
          if (typeMatch(s5, 1088ll) ?:
          true) then null
          else
            if typeMatch(s5,
            131712ll) then Nothing
            else fail(7157932, “$dateTrunc parameter ‘date’ must
  be coercible to date”)
  ?: null)]
  [1] filter {(traverseF(s6, lambda(l1.0) { ((l1.0 == s10) ?: false)
  }, false)
    && traverseF(s7, lambda(l2.0) {
        traverseF(getField(l2.0, “hostname”), lambda(l3.0)
            { isMember (l3.0, s11) }, false)
        }, false))
}
[1] scan s8 s9 none none none none none none lowPriority [s4 = cpu, s5
= time, s6 = measurement, s7 = tags]
@“3cb3a8c2-6688-4f3d-995e-f1a7d4fc98a8” true false
```

The equivalent block-enabled pipeline obtained by applying the rules of the vectorizer would look like this plan:

```
block_agg ...
project [s12 = (
let [ l101.0 = cellBlockGetFlatValuesBlock(s5) ]
in
cellFoldValues_P(
  let [ l102.0 = valueBlockDateTrunc(s8, s1, l101.0, “minute”, 5L,
“UTC”, “sun”) ]
  in
  valueBlockFillEmpty(
    let mask = valueBlockExists(l102.0)
    in
    valueBlockCombine(
      move(l102.0),
      let mask2 = valueBlockFillEmpty(valueBlockTypeMatch(l101.0,
1088ll), true)
      in
      valueBlockCombine(
        valueBlockNew(null, valueBlockSize(mask2)),
        let mask3 = valueBlockTypeMatch(l101.0, 131712ll)
        in
        valueBlockCombine(
          valueBlockNew(Nothing, valueBlockSize(mask3)),
          let current_mask = bitmapAnd(
                    s8,
                    bitmapNot(mask),
                    bitmapNot(mask2),
                    bitmapNot(mask3)
                  )
          in
          if (bitmapNone(current_mask))
              then valueBlockNew(Nothing, valueBlockSize(current_mask))
              else valueBlockNew(fail(7157932, “$dateTrunc parameter
            ‘date’ must be coercible to
          date”),
          valueBlockSize(current_mask)),
          mask3
        ),
mask2
),
      mask
    ), null)
, s5)]
filter { s8 = (
let mask = cellFoldValues_F(
              valueBlockFillEmpty(
                valueBlockEq(cellBlockGetFlatValuesBlock(s6), s10),
                false),
              s6)
in
valueBlockAnd(mask,
      if (bitmapNone(mask))
      then valueBlockNew(Nothing, valueBlockSize(mask))
      else cellFoldValues_F(
              valueBlockIsMember(cellBlockGetFlatValuesBlock(s7), s11),
              s7))
)}
ts_bucket_to_cellblock s4=cpu s5=time s6=measurement s7=tags.hostname
```

Performance Results and Analysis from Spike

In this sample experiment, dummy queries were used to prove out the block processing concept. These queries were run on a data set with 100 m measurements, hot in WT cache.

Some important notes for this example:

1. In this data set, the buckets were relatively large, storing 1000 values each. In general, having large buckets is important for block processing to do well.

2. A custom code path is written for decoding dates and doubles from the time series format. Without this, all of the queries would be entirely bottlenecked on the time spent to decode and the performance would be much worse.

3. Measurement values were chosen randomly. This is a worst case for time series since it makes the bucket metadata useless for certain operations. The goal here was to measure our “raw” processing speed over the time series data.

A typical document from the dataset:

```
  {
    “time” : ISODate(“2022-01-01T00:00:00Z”),
    “_id” : ObjectId(“647759df7f47c1f6c90283f1”),
    “x” : 92.82746980495155,
    “y” : 64.04053476197028,
    “arr” : [
      {
        “first” : NumberLong(1002)
      }
    ],
    “obj” : {
      “field” : 52.11937279565717
    }
  }
Query 0: Count all measurements in the collection
[{$count: “ct”}]
Classic: 23502ms
Prototype: 234ms
```

Query 0 Comments: In the classic engine each bucket is unpacked and then the results are counted one by one. In the prototype, the query uses the “count” field on each bucket and sums them up. No special rewrites were done for count queries, the system is aware that count is an algebraic accumulator (meaning we can compute it by doing a local count for each bucket and then sum the results), and the block implementation for time series data is aware of the count metadata.

```
Query 1: Count number of measurements greater than 50.
  [
    {
      “$match” : {
        “x” : {
          “$gt” : 50
        }
      }
    },
    {
      “$count” : “total”
    }
  ]
  Classic: 31406ms
Prototype: 2630ms
```

Query 1 Comments: The most expensive part in the prototype is the cost of decoding, taking about 60% of the time

```
Query 2: Count number of measurements greater than
50 then bin them by month
  [
    {
      “$match” : {
        “x” : {
          “$gt” : 50
        }
      }
    },
    {
      “$group” : {
        “_id” : {
          “$dateTrunc” : {
            “date” : “$time”,
            “unit” : “month”,
            “binSize” : 1
          }
        },
        “a” : {
          “$sum” : 1
        }
      }
    }
  ]
Classic: 63285ms
SBE: 2799ms
```

Query 3 Comments: Again similar to query 2. This one requires the min( ) to be computed without using metadata, since the buckets will get partially filtered, making the metadata unsuitable for min( ) computation. Even without the metadata optimization as in Query 0. the prototype is quicker.

```
Query 4: Example with array traversal:
  [
    {
      “$match” : {
        “arr.first” : {
          “$gt” : 1000
        }
      }
    },
    {
      “$count” : “total”
    }
  ]
Classic: 63177ms
Prototype: 29585ms
```

Query 4 comments: In this example, where the prototype does relatively poorly compared to other cases where 10×-100× are the improvements. While in this embodiment, the performance is still 2× faster than the classic engine, there is a cost of serializing BSON for every single measurement, which reduces the performance.

With an improved decoding API, this query may be improved significantly. While processing arrays will may be slower than processing scalars, it is possible to effectuate quicker block processing with arrays using the cell model, as described in the sections above.

### Additional Uses

In some embodiments, the system pipeline is configured to process data from other columnar data sources, i.e. persistent collections which store values in the same column or field path together. These may include:

1. Query columnar store via ADF: In some embodiments, a database system may query external columnar data stores through an abstraction or data federation (ADF) interface. The ADF interface may allow access to non MongoDB archive data sources such as Parquet stored in S3 (or Parquet archival of BSON data). Such sources provide a highly compressed columnar layout. In some embodiments, the system may be configured to create external data source in mongoDB. In those systems, once the Parquet source is supported, block processing may make queries on these data sources extremely performant. Furthermore, block processing may be extended further by utilizing additional properties, such as metadata fields, exposed by Parquet, such as type and schema. These techniques may provide enhanced query performance and efficiency in a cloud-based database service environment, such as Atlas.

2. Columnar Index: In some embodiments, a query may be evaluated using a columnar index without requiring access to the full set of underlying documents. For example, when a query can be resolved entirely by scanning one or more columnar indexes, the system may employ block-based processing techniques to execute the query. However, certain challenges arise in implementing block processing for columnar indexes. In particular, the index entries may not be “dense” with respect to the corresponding documents, thereby creating alignment issues across multiple sparse paths. To address these challenges, the system may implement a mapping process to associate column values with corresponding blocks of documents or records. Once such mapping is performed, the general principles of block processing described herein may be applied to columnar index scans, thereby enabling more efficient query evaluation.

3. Covered Index Scans: In further embodiments, covered index scans may be optimized through use of a ValueBlock interface. Conventional approaches to covered index scans often incur significant computational overhead by converting KeyStrings into BSON objects before evaluating predicates or retrieving values.

By contrast, the disclosed system allows certain operations to be executed directly on KeyStrings. For example, equality predicates on a trailing field of an index entry may be applied to the KeyString representation without first performing a conversion into BSON. This approach reduces conversion overhead, improves query processing efficiency, and enables block-wise execution of operations in covered index scans.

### Example Special-Purpose Computer System

A special-purpose computer system can be specially configured as disclosed herein. According to one embodiment the special-purpose computer system is configured to perform any of the described operations and/or algorithms (e.g., database operations). The operations and/or algorithms described herein can also be encoded as software executing on hardware that defines a processing component, that can define portions of a special purpose computer, reside on an individual special-purpose computer, and/or reside on multiple special-purpose computers.

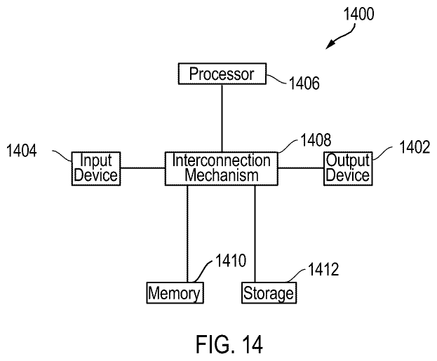

FIG. 14 shows a block diagram of an example special-purpose computer system 1400 on which various aspects of the present invention can be practiced. For example, computer system 1400 may include a processor 1406 connected to one or more memory devices 1410, such as a disk drive, memory, or other device for storing data. Memory 1410 is typically used for storing programs and data during operation of the computer system 1400. Components of computer system 1400 can be coupled by an interconnection mechanism 1408, which may include one or more busses (e.g., between components that are integrated within a same machine) and/or a network (e.g., between components that reside on separate discrete machines). The interconnection mechanism enables communications (e.g., data, instructions) to be exchanged between system components of system 1400.

Computer system 1400 may also include one or more input/output (I/O) devices 1402-1404, for example, a keyboard, mouse, trackball, microphone, touch screen, a printing device, display screen, speaker, etc. Storage 1412 typically includes a computer readable and writeable nonvolatile recording medium in which computer executable instructions are stored that define a program to be executed by the processor or information stored on or in the medium to be processed by the program.

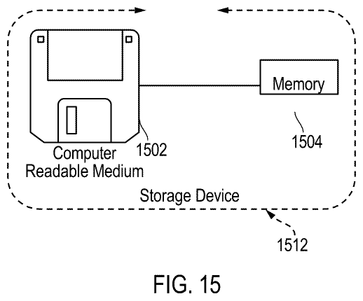

The medium can, for example, be a flash memory as shown in FIG. 15. Typically, in operation, the processor causes data to be read from the nonvolatile recording medium into another memory 1504 that allows for faster access to the information by the processor than does the medium. This memory is typically a volatile, random access memory such as a dynamic random-access memory (DRAM) or static memory (SRAM). According to one embodiment, the computer-readable medium comprises a non-transient storage medium on which computer executable instructions are retained.

Referring again to FIG. 15, the memory can be located in storage 1412 as shown. The processor 1406 generally manipulates the data within the memory 1410, and then copies the data to the medium associated with storage 1412 after processing is completed. A variety of mechanisms are known for managing data movement between the medium and integrated circuit memory element and the invention is not limited thereto. The invention is not limited to a particular memory system or storage system.

The computer system may include specially-programmed, special-purpose hardware, for example, an application-specific integrated circuit (ASIC). Aspects of the invention can be implemented in software, hardware or firmware, or any combination thereof. Although computer system 1400 is shown by way of example, as one type of computer system upon which various aspects of the invention can be practiced, it should be appreciated that aspects of the invention are not limited to being implemented on the computer system as shown in FIG. 14. Various aspects of the invention can be practiced on one or more computers having a different architectures or components than that shown in FIG. 14.

It should be appreciated that the invention is not limited to executing on any particular system or group of systems. Also, it should be appreciated that the invention is not limited to any particular distributed architecture, network, or communication protocol.

Various embodiments of the invention can be programmed using an object-oriented programming language, such as Java, C++, Ada, or C#(C-Sharp). Other programming languages may also be used. Alternatively, functional, scripting, and/or logical programming languages can be used. Various aspects of the invention can be implemented in a non-programmed environment (e.g., documents created in HTML, XML or other format that, when viewed in a window of a browser program, render aspects of a graphical-user interface (GUI) or perform other functions). The system libraries of the programming languages are incorporated herein by reference. Various aspects of the invention can be implemented as programmed or non-programmed elements, or any combination thereof.

A distributed system according to various aspects may include one or more specially configured special-purpose computer systems distributed among a network such as, for example, the Internet. Such systems may cooperate to perform functions related to hosting a partitioned database, managing database metadata, monitoring distribution of database partitions, monitoring size of partitions, splitting partitions as necessary, migrating partitions as necessary, identifying sequentially keyed collections, optimizing migration, splitting, and rebalancing for collections with sequential keying architectures.

### CONCLUSION

Having thus described several aspects and embodiments of this invention, it is to be appreciated that various alterations, modifications and improvements will readily occur to those skilled in the art. Such alterations, modifications, and improvements are intended to be part of this disclosure and are intended to be within the spirit and scope of the invention. Accordingly, the foregoing description is by way of example only.

Use of ordinal terms such as “first,” “second,” “third,” “a,” “b,” “c,” etc., in the claims to modify or otherwise identify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

1. A system comprising a pipeline comprising:
a first stage configured to create a plurality of BSON documents from input data;
a block processing stage configured to format the plurality of BSON documents into one or more blocks and to provide an access interface to the one or more blocks;
a query stage configured to execute a query to the one or more blocks using the access interface to generate an output array responsive to the query; and
a decomposition stage configured to transform the output array into one or more slots of scalar data values.

2. The system of claim 1, wherein the input data comprises time series data.

3. The system of claim 1, wherein the one or more blocks comprises a plurality of type and value pairs.

4. The system of claim 1, wherein the query stage is further configured to traverse a vectorized path through the one or more blocks.

5. The system of claim 1, wherein the one or more blocks comprises metadata and the query is executed in accordance with the metadata.

6. The system of claim 1, wherein the query is executed in accordance with one or more block properties.

7. The system of claim 1, wherein the one or more blocks comprises cells, wherein a single cell corresponds to a single path within the BSON document.

8. The system of claim 1, wherein the query stage is further configured to unwind blocks.

9. A method comprising:
creating a plurality of BSON documents from input data;
formatting the plurality of BSON documents into one or more blocks and providing an access interface to the one or more blocks;
executing a query to the one or more blocks using the access interface to generate an output array responsive to the query; and
transforming the output array into one or more slots of scalar data values.

10. The method of claim 9, wherein the input data comprises time series data.

11. The method of claim 9, wherein the one or more blocks comprises a plurality of type and value pairs.

12. The method of claim 9 further comprising, traversing a vectorized path through the one or more blocks.

13. The method of claim 9, wherein the one or more blocks comprises metadata and executing the query in accordance with the metadata.

14. The method of claim 9, further comprising executing the query to the one or more blocks in accordance with one or more block properties.

15. The method of claim 9, wherein formatting the one or more blocks such that a single cell corresponds to a single path within the BSON document.

16. The method of claim 9, wherein executing the query to the one or more blocks includes unwinding the one or more blocks.

17. A non-transitory computer-readable medium containing instruction that, when executed, cause at least one computer hardware processor to perform:
creating a plurality of BSON documents from input data;
formatting the plurality of BSON documents into one or more blocks and providing an access interface to the one or more blocks;
executing a query to the one or more blocks using the access interface to generate an output array responsive to the query; and
transforming the output array into one or more slots of scalar data values.

18. The non-transitory computer-readable medium of claim 17, wherein the input data comprises time series data.

19. The non-transitory computer-readable medium of claim 17, wherein the one or more blocks comprises a plurality of type and value pairs.

20. The non-transitory computer-readable medium of claim 17, wherein the instruction, when executed, causes at least one computer hardware processor to further perform traversing a vectorized path through the one or more blocks.

21.-33. (canceled)
